(19) United States
(12) Patent Application Publication
(10) Pub. No.: US 2015/0177396 A1
(43) Pub. Date: Jun. 25, 2015

(54) Controlling Survey Source Signal Phases

(71) Applicant: WesternGeco L.L.C., Houston, TX (US)

(72) Inventors: Claudio Bagaini, Cottenham (GB); Ian Moore, Queenstown (NZ)

(21) Appl. No.: 14/571,135

(22) Filed: Dec. 15, 2014

Related U.S. Application Data
(60) Provisional application No. 61/919,446, filed on Dec. 20, 2013.

(51) Int. Cl. G01V 1/02

(52) U.S. Cl. CPC G01V 1/02

(57) ABSTRACT

A controller controls phases of signals produced by survey sources according to a frequency of the signals. The controlling includes controlling the survey sources to be in phase for frequencies less than a predetermined frequency, and randomizing phases of the signals emitted by the survey sources for frequencies greater than the predetermined frequency, wherein the randomizing includes applying a smoothing operator in a specified frequency range, and emit signals with different phases for frequencies greater than the predetermined frequency.

### CROSS REFERENCE TO RELATED APPLICATION

This application claims the benefit under 35 U.S.C. §119(e) of U.S. Provisional Application No. 61/919,446, filed Dec. 20, 2013, which is hereby incorporated by reference.

### BACKGROUND

Seismic surveying is used for identifying subsurface elements, such as hydrocarbon reservoirs, freshwater aquifers, gas injection zones, and so forth. In seismic surveying, seismic sources (such as seismic vibrators or other types of sources) are placed at various locations on a land surface or sea floor or at another location. The seismic sources are activated to generate seismic waves directed into a subsurface structure.

The seismic waves generated by a seismic source travel into the subsurface structure. A portion of the seismic waves are reflected back to the surface for receipt by seismic receivers (e.g. hydrophones, geophones, accelerometers, etc.). These seismic receivers produce signals that represent detected seismic waves. Signals from seismic receivers are processed to yield information about the content and characteristic of the subsurface structure.

### SUMMARY

In accordance with some implementations, a controller controls phases of signals produced by survey sources according to a frequency of the signals. The controlling includes controlling the survey sources to emit signals in phase for frequencies less than a predetermined frequency, and emit signals with different phases for frequencies greater than the predetermined frequency.

Other or additional features will become apparent from the following description, from the drawings, and from the claims.

### BRIEF DESCRIPTION OF THE DRAWINGS

Some implementations are described with respect to the following figures.

FIG. 1 is a schematic side view of an example survey arrangement according to some implementations.

FIG. 2 is a schematic diagram of generating seismic energy using phased-dithered seismic sources, according to some implementations.

FIG. 3 is a schematic top view of an example survey arrangement according to some implementations.

FIG. 4 is a flow diagram of a process according to some implementations.

### DETAILED DESCRIPTION

A survey arrangement to survey a target structure, such as a subsurface structure, can include an arrangement of survey receivers and survey sources. In seismic surveying, the survey receivers are seismic sensors that are used to measure seismic data, such as displacement, velocity, or acceleration. Seismic sensors can include geophones, accelerometers, microelectromechanical systems (MEMS) sensors (e.g. MEMS accelerometers), or any other types of sensors that measure translational motion of a surface in one or more directions. A MEMS sensor includes elements with sizes in the nanometers or micrometers range. One or more of the elements of the MEMS sensor may be moveable. A seismic sensor that measures translational motion can be referred to as a particle motion sensor.

A survey source that produces seismic signals can be referred to as a seismic source. The seismic signals are propagated into a subsurface earth structure. In some implementations, the seismic source can be in the form of a seismic vibrator, which has at least one moveable element that is actuated to oscillate between different positions to cause vibrations that cause production of seismic signals that are propagated into the subsurface earth structure.

Although reference is made to performing surveying to characterize a subsurface earth structure, techniques or mechanisms according to some implementations can also be applied to perform surveys of other target structures, such as human tissue, a mechanical structure, plant tissue, animal tissue, a solid volume, a substantially solid volume, a liquid volume, a gas volume, a plasma volume, a volume of space near and/or outside the atmosphere of a planet, asteroid, comet, moon, or other body, and so forth. In addition, the following describes seismic sources and seismic receivers that are part of seismic survey equipment. In other implementations, other types of survey equipment can be used, which can include other types of survey sources and survey receivers.

A seismic vibrator is an example of a survey source having certain controllable characteristics, such as one or more of frequency, phase, and amplitude. A seismic survey technique that uses one or more seismic vibrators can be referred to as a “vibroseis” technique. The frequency of an output emitted by the seismic vibrator can be controlled, such that the signal emitted by the output of the seismic vibrator is at a specific frequency (or frequencies). In some cases, the signals output by the seismic vibrator can be swept within a specified frequency range, from a first frequency to a second frequency of the frequency range.

The signal sweep that is produced by the seismic vibrator may be an oscillating signal of a continuously varying frequency, increasing or decreasing monotonically within a given frequency range. The frequency of the seismic sweep may start low and increase with time (an upsweep) or the frequency may begin high and gradually decrease (a downsweep). To produce the frequency sweep, the control input to the seismic vibrator includes input signals (also referred to as “pilot signals”) that sweep across frequencies from a first frequency to a second frequency (the “sweep range”). The input signals (or pilot signals) that are input to the seismic vibrator controls the output frequency of the seismic vibrator.

In seismic surveying arrangements that include multiple seismic sources, it may be desirable to employ simultaneous source techniques, in which seismic sources are activated relatively closely in time with respect to each other. Use of “simultaneous seismic sources” can refer to a survey acquisition technique or arrangement in which a measured data record can include contributions from multiple seismic sources, which are activated within a specified time interval where activation of a first seismic source contributes to (interferes with) seismic data acquired due to activation of at least one a second seismic source. Such seismic sources are also referred to as being simultaneously activated.

In some cases, it may be difficult to generate adequate seismic energy at low frequencies (frequencies lower than a predefined threshold). At low frequencies, there may be relatively high ambient and electronic noise levels. Traditionally, a longer time may have to be spent to generate seismic energy at lower frequencies (due to waiting longer between seismic source shots), and/or multiple sweeps may have to be performed in the same area to generate greater seismic energy to yield sufficient signal-to-ambient noise ratio (SANR). However, with either of the foregoing techniques, data acquisition rates can suffer since a survey operator may have to spend a greater amount of time to acquire survey data at the lower frequencies.

In accordance with some implementations, techniques or mechanisms are provided to increase the SANR at lower frequencies, by employing simultaneous and in-phase sweeping of seismic sources at lower frequencies (those frequencies less than a predetermined threshold). In other words, multiple seismic sources that are activated simultaneously are in-phase (the phase of the signals produced by the multiple seismic sources are the same as each other or within a predetermined threshold of each other, i.e. the difference in phase of the signals produced by the multiple seismic sources is less than the predetermined threshold). As noted above, multiple seismic sources are activated simultaneously if they are activated within a time interval where activation of a first seismic source contributes to seismic data acquired due to activation of at least another seismic source.

However, in accordance with some implementations, at higher frequencies (frequencies greater than the predetermined threshold), the simultaneously-activated seismic sources are controlled to not be in-phase (in other words, phase dithering is applied). Rather, the phases of the simultaneously-activated seismic sources at higher frequencies are randomized, based on use of a random variable. Further, in accordance with some implementations, a slowly varying function (which can also be referred to as a “smoothing function”) is used to provide a smooth transition of the phase difference of simultaneously-activated seismic sources between the lower frequencies and the higher frequencies, to avoid an abrupt transition of the phases of the simultaneously-activated seismic sources when sweeping from lower frequencies to higher frequencies. A slowly varying function when applied to control the phases of the simultaneously-activated seismic sources causes the phase within a specified time interval to vary as a function of frequency by less than a predefined rate, such as X Δphase per Δfrequency, where X is a predetermined value.

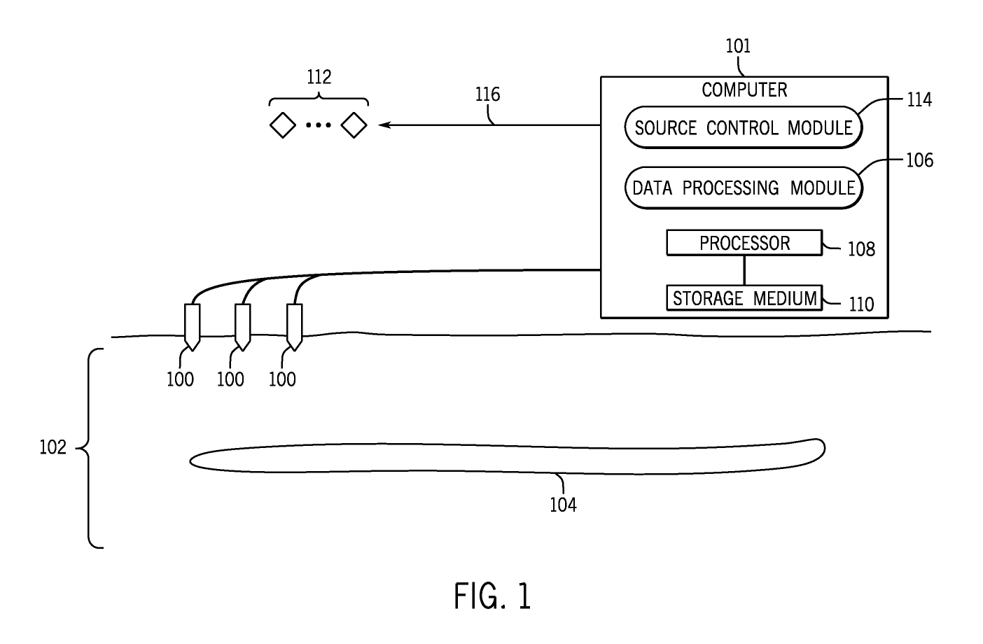

FIG. 1 is a schematic diagram of a land-based survey arrangement that includes survey sensor devices 100, which can include particle motion sensors as discussed above. The sensor devices 100 may also include hydrophones or other types of seismic sensors or survey sensors. In different examples, the sensor devices 100 can be deployed in a marine survey arrangement, such as on a streamer towed through a body of water, or on a seabed cable.

Measurements acquired by the sensor devices 100 are transmitted to a computer 101, where the measurements are recorded (stored in a non-transitory computer-readable or machine-readable storage medium or storage media 110). The measurements are made by the sensor devices 100 in response to seismic waves produced by seismic sources 112 (e.g. seismic vibrators or other types of survey sources whose phases can be controlled). The seismic waves are propagated into a subsurface structure 102, and reflected from a subsurface element 104 of interest. The reflected waves are detected by the sensor devices 100.

The computer 101 includes a data processing module 106, which can be implemented with machine-readable instructions that are executable on one or more processors 108 coupled to the storage medium (or storage media) 110. The data processing module 106 can process measurement data from the sensor devices 100 to characterize the subsurface structure 102, such as to produce an image or a model of the subsurface structure 102.

The computer 101 can also include a source control module 114, which is able to control the seismic sources 112. The source control module 114 can be implemented with machine-readable instructions that are executable on one or more processors 108. In some examples, the source control module 114 is able to control the phases of simultaneously-activated seismic sources 112, such as according to techniques discussed above. The computer 101 can be coupled to the seismic sources 112 over a wired or wireless communications medium 116 to perform control of the seismic sources 112.

Control signals sent over the communications medium 116 to the seismic sources 112 can cause control of pilot signals used to control activation of the seismic sources (e.g. seismic vibrators).

Although the data processing module 106 and source control module 114 are depicted as being part of the same computer 101, it is noted that in other examples, the data processing module 106 can be deployed on a computer that is different from a computer used to deploy the source control module 114.

More generally, the source control module 114 can be part of a controller for the seismic sources 112, where the controller can be implemented with a computer or multiple computer, or alternatively, with another type of control device.

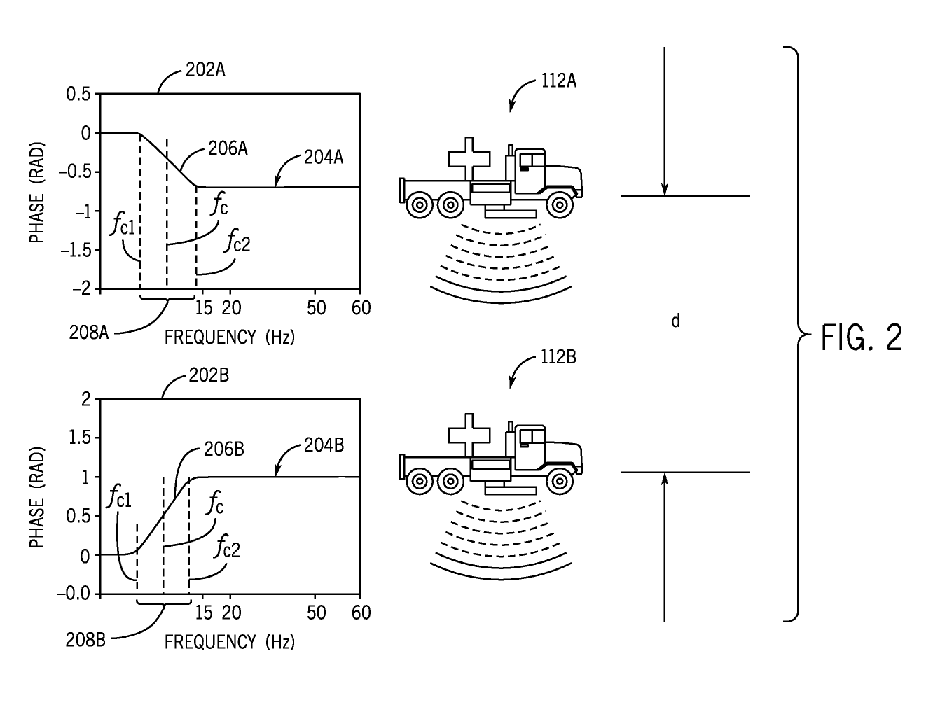

FIG. 2 is a schematic diagram illustrating two seismic vibrators 112A and 112B, which are separated by a distance d. The seismic vibrators 112A and 112B can be part of the seismic sources 112 depicted in FIG. 1.

FIG. 2 also shows two charts 202A and 202B that illustrate output signals produced by the respective seismic vibrators 112A and 112B. The chart 202A depicts a curve 204A, which represents phase (vertical axis) of an output signal produced by the seismic vibrator 112A as a function of frequency (horizontal axis). Similarly, the chart 202B depicts a curve 204B that represents the phase of an output signal produced by the seismic vibrator 112B as a function of frequency.

As represented by the curves 204A and 204B, at lower frequencies (frequencies less than a predetermined frequency referred to as a cutoff frequency, f_{c1}, the seismic signals produced by the seismic vibrators 112A and 112B are in-phase. However, at higher frequencies, greater than f_{c1}, the seismic signals produced by the seismic vibrators 112A and 112B are out-of-phase. Each curve 204A or 204B has a smooth transition 206A or 206B, respectively, that is provided by a slowly varying function (or smoothing function) to allow for a smooth transition of seismic signals produced by each seismic vibrator during a sweep between lower frequencies and higher frequencies. The function that defines the values of the phase at each frequency across a frequency range and therefore includes also the smoothing function is referred to as a phase encoding function. In FIG. 2, the smoothing function is applied in the frequency interval {f_{c1}, f_{c2}}, while the phase encoding function is applied across a frequency range that includes the frequency interval {f_{c1}, f_{c2}} as well as frequencies outside the frequency interval {f_{c1}, f_{c2}}.

In the example charts 202A and 202B shown in FIG. 2, at frequencies lower than f_{c1}, the phases of the seismic signals produced by the seismic vibrators 112A and 112B are both at 0 (or some other common phase value). However, at frequencies greater than f_{c1}, the phase of the seismic signal produced by the seismic vibrator 112A is at −1 (or some other negative phase value less than the common phase value), while the phase of the seismic signal produced by the seismic vibrator 112B is at +1 (or some other positive phase value greater than the common phase value).

Although FIG. 2 shows a constant phase of the output signal produced by each of the seismic vibrators 112A and 112B at frequencies greater than f_{c1}, it is noted that the phase of the output signal produced by each seismic vibrator at frequencies greater than f_{c1} is randomized, as discussed further below.

In addition to being able to control the phases of signals produced by the seismic sources, such as the seismic vibrators 112A and 112B, the amplitudes of the seismic signals produced by the seismic vibrators 112A and 112B can also be controlled according to some implementations (discussed further below).

FIG. 2 represents the generation of seismic energy by simultaneously-activated seismic vibrators 112A and 112B, whose phases are controlled. The control of phases according to some implementations provides phase-dithered seismic sources. In some implementations, the seismic sources that are controlled according to some implementations are continuous seismic sources. A continuous seismic source produces a continuous seismic signal that has content over a predefined frequency bandwidth. As an example, a continuous seismic signal can be produced by using a pseudorandom sweep.

By using source control techniques or mechanisms according to some implementations, the SANR of data measured by survey receivers can be improved for lower frequencies, and in addition, the data acquisition rate can be increased (since successive shots can be performed closer in time to each other, and multiple sweeps in the same area can be avoided).

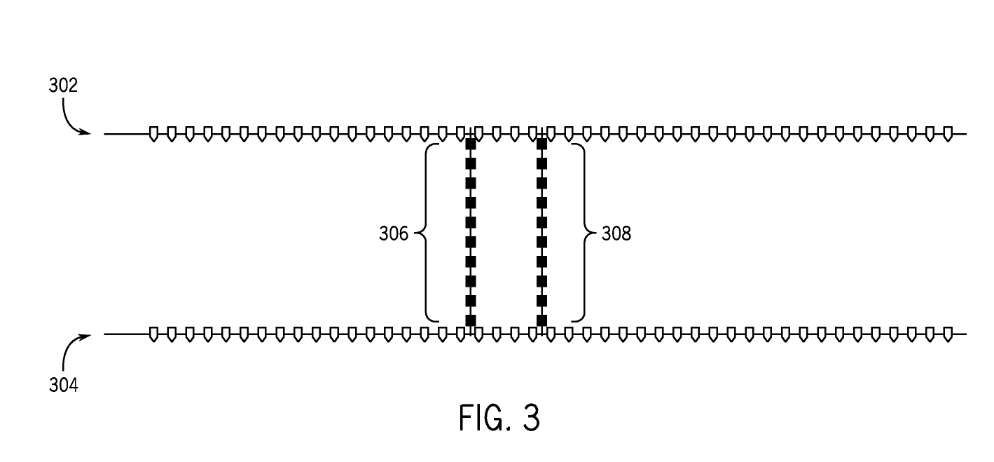

FIG. 3 is a schematic top view of an example arrangement of sensor devices and seismic sources. In the example arrangement shown in FIG. 3, two lines (e.g. rows) of 302 and 304 of sensor devices are provided, where the two rows 302 and 304 of sensor devices are spaced apart by some distance. In addition, two lines (e.g. columns) 306 and 308 of seismic sources are provided between the rows 302 and 304 of seismic receivers.

Although a specific arrangement of sensor devices and seismic sources are depicted in FIG. 3, it is noted that in other examples, other arrangements of sensor devices and seismic sources can be employed.

As discussed above in connection with FIG. 2, a cutoff frequency, f_{c1}, can be defined for the control of phases of seismic signals produced by simultaneously-activated seismic vibrators. Seismic signals produced by the simultaneously-activated seismic vibrators lower than the cutoff frequency, f_{c1}, are swept in-phase, while seismic signals produced by the simultaneously-activated seismic vibrators greater than the cutoff frequency, f_{c1}, have phases that are randomized.

The cutoff frequency, f_{c1}, can be set based on a shortest horizontal wavelength of a seismic signal of interest (target signal to be measured, such as a signal corresponding to a seismic wave reflected from a subsurface structure or other target structure). This cutoff frequency, f_{c1}, can be based on one or more of the following factors: the distance between seismic sources, the propagation velocities and components (or other characteristics) of measured wavefields, or other factors. The cutoff frequency, f_{c1}, is set lower if the target waves travel horizontally such as surface waves.

The foregoing describes how phases and amplitudes can be controlled for a pair of simultaneously-activated seismic sources. Note, however, that techniques or mechanisms according to some implementations can be applied to more than two simultaneously-activated seismic sources.

Two continuous seismic sources emit their signals from two locations that are separated by a distance d (such as shown in FIG. 2) in-phase up to frequencies close to the cut-off frequency, f_{c1}. In some implementations, the phase differences between the two emitted signals can be a smooth function of the instantaneous frequency of the emitted signals. The transition between the frequencies swept in-phase and those that are not in phase can be smooth, based on use of a slowly varying function (smoothing function) discussed further below. A set of seismic vibrator sweeps that satisfies this condition can be defined as follows:

sⱼ(t)=A(t)cos(φⱼ(t))=A(t)cos(θ(t)+γⱼ(t)), Eq. (1)

where sⱼ(t) is the seismic signal (emitted by a seismic vibrator) produced by sweep j (of a seismic vibrator at a given position), A(t) is a sweep envelope (which can be a predefined function that defines a general profile of the emitted seismic signal), θ(t) is the phase of an original sweep (i.e. the sweep before application of phase dithering according to some implementations), γⱼ(t) is the phase dithering function for sweep j, and φⱼ(t)=θ(t)+γⱼ(t).

Sweep j refers to the activation of a specific seismic source at a respective location. Different seismic sources and/or different locations at which a seismic source is activated can correspond to a specific sweep j. For example, sweep 1 and sweep 2 can be two different sweeps performed by the same seismic vibrator at different locations, or can be performed by two different seismic vibrators at different locations.

The instantaneous frequency of an original sweep can be expressed as follows:

$${f}_{i} ( t ) = \frac{1}{2 π} \frac{d θ ( t )}{d t} , \qquad ( Eq . 2 )$$

which can be a monotonic function of time t. The instantaneous frequency, fᵢ(t), can be inverted and denoted as tᵢ(f).

In accordance with some implementations, the phase dithering function, γⱼ(t), can be expressed as a slowly varying function (smoothing function) of the original sweep instantaneous frequency, fᵢ(t), as:

$$\begin{matrix}{γ}_{j} ( {t}_{i} ( {f}_{i} ) ) = ζ ( {f}_{i} ) \\ = \{ \begin{matrix}0 & for {f}_{i} < {f}_{c 1} = {f}_{c} - Δ f \\ α ( \frac{{f}_{i} - {f}_{c}}{Δ f} ) {ψ}_{j} , & for {f}_{c 1} < {f}_{i} < {f}_{c 2} = {f}_{c} + Δ f \\ {ψ}_{j} & for {f}_{i} > {f}_{c 2}\end{matrix} .\end{matrix} \qquad ( Eq . 3 )$$

In Eq. 3, α(f) is the smoothing function discussed above, and varies smoothly (e.g. monotonically) from α(−1)=0 to α(1)=1, or between any initial value and final value. In the example of FIG. 2, the smoothing function is applied in the frequency range represented as 208A and 208B, e.g. f_{c}−Δf to f_{c}+Δf. Thus, f_{c}=f_{c1}+Δf, and f_{c2}=f_{c1}+2Δf. In Eq. 3, the smoothing function is a function of

$$\frac{{f}_{i} - {f}_{c}}{Δ f} ,$$

which is a difference between the instantaneous frequency, fᵢ, and the frequency, f_{c}, divided by Δf. The phase of an emitted signal, sⱼ(t), is randomized by using a random variable, Ψⱼ, which can be a function of shot position. Ψⱼ can be a random variable whose probably density function is uniformly distributed in the interval [−π, π].

In other examples, Ψⱼ can be deterministically chosen, such as according to:

$${ψ}_{i} = [ \frac{i π}{n} ] , where \frac{- n}{2} \leq i \leq \frac{n}{2} , \qquad ( Eq . 4 )$$

where n is a (partial) stacking fold or an integer sub-multiple of it, and i is an integer and increments from shot to shot.

The sweep envelope, A(t), is determined by the seismic vibrator mechanical specifications, which can be defined as a function of the sweep instantaneous frequency, fᵢ(t), and a goal to avoid sharp discontinuities of the sweep envelope that generate Gibbs' effects. In some examples, the sweep envelope, A(t), is defined as:

A(t)=A(tᵢ(fᵢ))=M(fᵢ). (Eq. 5)

In some examples, techniques that produce M(f) (more generally referred to as an amplitude envelope) are described in U.S. Pat. No. 7,327,633. In other examples, other techniques of producing M(f) can be employed.

The phase dithering function, γⱼ(t), can change a sweep's power spectral density. The instantaneous frequency, f_{d}(t), of a dithered sweep is in the following range:

$$\frac{1}{2 π} {ϕ}^{′} ( t ) = {f}_{d} ( t ) + \frac{1}{2 π} {γ}_{i}^{′} ( t ) . \qquad ( Eq . 6 )$$

For a particular choice of γⱼ(t) in Eq. 3 above, the instantaneous frequency, f_{d}(t), of a dithered sweep differs from the instantaneous frequency, fᵢ(t), of an original sweep (sweep before application of phase dithering) just in the time interval corresponding to fᵢ(t) being in the neighborhood (within some predefined range) of the cutoff frequency, f_{c1}. For example, in FIG. 2, this neighborhood can be expressed as the frequency range 208A or 208B, e.g. f_{c1} to f_{c1}+2Δf.

In some examples, the frequency range in which an amplitude spectrum of measured data is affected by phase dithering (the randomizing of phases of emitted signals from simultaneously-activated survey sources) includes just the following: f_{c}−Δf<fᵢ<f_{c}+Δf, where f_{c}=f_{c1}+Δf. This is an indication that the quasi-stationary condition is satisfied. At frequencies where phase dithering affects the amplitude spectrum of measured data, such effects can be compensated for using a deterministic shot consistent deconvolution approach or some other processing technique.

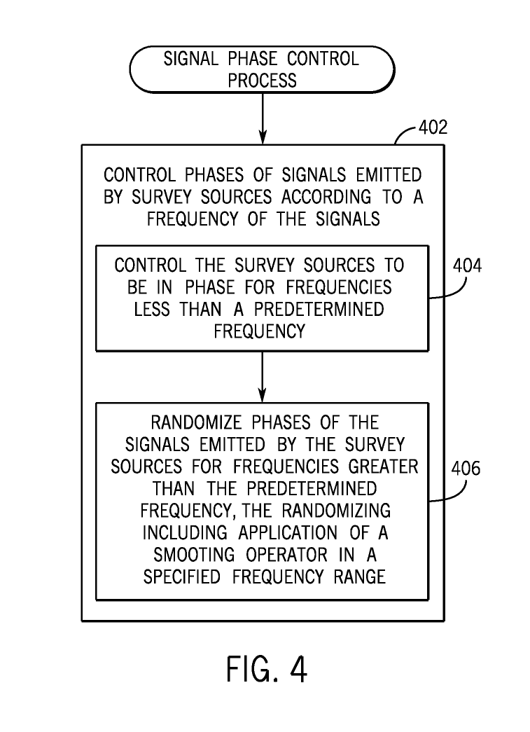

FIG. 4 is a flow diagram of a signal phase control process according to further implementations. The process can be performed by the source control module of FIG. 1, whether executed on the computer 101 or on a controller. The process controls (at 402) phases of signals emitted by survey sources according to a frequency of the signals. The controlling includes controlling (at 404) the survey sources to be in phase for frequencies less than a predetermined frequency (e.g. the cutoff frequency or a frequency within a frequency range that includes the cutoff frequency), and randomizing (at 406) phases of the signals emitted by the survey sources for frequencies greater than the predetermined frequency, wherein the randomizing includes applying a smoothing operator in a specified frequency range including the predetermined frequency to smooth a transition of the phases of the signals in the specified frequency range

Two or more seismic sources (which are simultaneously activated) can be considered a point source if their spatial separation is much smaller than the shortest horizontal wavelength of interest (the horizontal wavelength of the target signal to be measured). The extent of the horizontal wavelength at the cutoff frequency, f_{c1}, can depend on the angle of incidence of the recorded wavefield that in onshore (land-based) and offshore (marine) surface seismic arrangements can be no more than 30° with respect to the vertical direction, in some examples. At the cutoff frequency, the shortest horizontal wavelength can be expressed as:

$${λ}_{m} = \frac{{v}_{m}}{{f}_{c 1} sin β} , \qquad ( Eq . 7 )$$

where vₘ is the minimum phase velocity of interest, and β is the maximum angle of incidence with respect to the vertical direction. The maximum distance d between seismic sources at which phase dithering according to some implementations can be set to be much less than vₘ. In other words, the distance between seismic sources (such as d shown in FIG. 2) can be selected by a survey operator based on the horizontal wavelength of interest, λₘ, expressed in Eq. 7. However, in other examples, a less conservative choice of d (i.e. selection of a larger value of d) can provide benefits in in low SANR conditions.

In onshore (land-based) survey arrangements, the near-surface P wave velocity can be lower than a near-surface P wave velocity for offshore (marine) survey arrangements. As a result, the cutoff frequency, f_{c1}, can be set higher for the same angle of incidence. A P wave refers to a compressional wave that propagates in a subsurface structure, and a near-surface P wave refers to a P wave that propagates near (to within a predefined depth of) the earth surface.

In onshore survey arrangements, surface waves, which propagate with phase and group velocities lower than the near-surface P wave velocities, generate the shortest horizontal wavelengths. However, since surface waves can be considered noise, the attenuation of the surface waves due to the in-phase activation of seismic sources may be beneficial. If the preservation of surface waves is desirable, e.g. for the determination of the near-surface S (shear) wave velocity profile based on surface wave inversion, the cutoff frequency can be determined based on the investigation depth of the surface waves. Surface waves can be maximally sensitive to the shear wave velocity at approximately one third of the shear wave's wavelength.

Simultaneous activation of multiple seismic sources causes data (measured by one or more seismic receivers) responsive to a first seismic source to be interfered with by one or more other seismic sources of the multiple seismic sources. In some implementations, a source separation process, such as described in PCT Application No. WO 2010/123639, can be employed to separate data responsive to individual ones of the multiple seismic sources. When data is acquired by seismic receiver(s) in response to simultaneously-activated seismic sources for which phase dithering according to some implementations has been applied, source separation can work well for frequencies greater than the cutoff frequency. The phase separation works well at the higher frequencies because phase dithering is applied at the higher frequencies.

At lower frequencies, where phase dithering is not performed such that the simultaneously-activated seismic sources are in phase, the low-frequency seismic energy can be equally divided between the seismic sources.

The following describes further considerations that may be involved in the phase dithering techniques or mechanisms according to some implementations. A land-based acquisition system can impose acquisition rules such that the signals from two or more land-based seismic sources are triggered (for simultaneous activation) when they are simultaneously ready at two or more locations at which seismic energy is to be emitted.

In a marine-based acquisition system, including an acquisition system in which seismic sources are towed on a tow cable (or tow cables), the continuous motion of the seismic sources through a body of water when towed can lead naturally to the condition in which two or more (arrays of) seismic sources towed by the same marine vessel are simultaneously ready and have a predefined distance between them.

Seismic surveys are designed according to two main criteria: (1) a multidimensional wavefield is sampled in such a way that spatial aliasing is eliminated or reduced, and (2) sufficient seismic energy is transmitted to the subsurface structure to overcome attenuation of the subsurface structure and any additive noise.

Seismic surveys can be designed such that the shot interval (time interval between shots or activations of seismic sources) is frequency dependent. If the shot interval is instead designed according to a maximum frequency, the components of the wavefield at the lowest frequencies and longest wavelengths can be spatially oversampled.

Separation of signals generated due to simultaneously-activated seismic sources whose spatial separation is much smaller than the signal wavelengths that they emit may not have to be performed because the simultaneously-activated seismic sources act as a point source.

Simultaneous and in-phase sweeping can be an effective way to increase the SANR for seismic sources whose spatial separation is much smaller than the horizontal wavelength. Phase differences produce detuning and therefore a reduction of the SANR.

Signals at higher frequencies are more rapidly attenuated than signals at lower frequencies when traveling in a subsurface structure. Consequently, the listening time for higher frequencies can be lower than that for lower frequencies.

Seismic energy at higher frequencies propagates with short spatial wavelength that has to be sampled with a finer source and receiver grid. The preservation of surface waves or direct arrivals can result in use of an even finer spatial sampling.

As noted above, various tasks can be performed by the data processing module 106 and source control module 114 of FIG. 1 that can be implemented as machine-readable instructions that can be loaded for execution on a processor (or processors). A processor can include a microprocessor, microcontroller, physical processor module or subsystem, programmable integrated circuit, programmable gate array, or another physical control or computing device.

The storage medium (or storage media) 110 of FIG. 1 can include different one or more forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
emitting, by simultaneously-activated plural survey sources, signals that are in phase for frequencies less than a predetermined frequency, and that have different phases for frequencies greater than the predetermined frequency,
wherein phases of the signals emitted by the plural survey sources in a frequency range from the predetermined frequency to a second frequency are based on application of a smoothing function to provide a smooth a transition of the phases of the signals in the frequency range.

2. The method of claim 1, wherein emitting the signals by the plural survey sources comprises emitting the signals by plural seismic vibrators.

3. The method of claim 1, wherein phases of the signals greater than the second frequency are randomized.

4. The method of claim 1, wherein the predetermined frequency is a cutoff frequency based on a shortest wavelength of a target signal to be measured.

5. The method of claim 1, wherein the smoothing function is a function defined in the frequency range, a value produced by the smoothing function being based on a difference between an original sweep instantaneous frequency and the predetermined frequency, wherein the original sweep instantaneous frequency is an instantaneous frequency of a sweep prior to application of a phase encoding function that produces the phases of the signals emitted by the plural survey sources.

6. The method of claim 1, wherein the smoothing function changes monotonically from an initial value for a first value of a frequency to a final value for a second value of a frequency in the frequency range.

7. The method of claim 6, wherein the final value of the smoothing function is a random variable.

8. The method of claim 7, wherein the random variable is a function of shot position.

9. The method of claim 6 where the final value of the smooth function is deterministically chosen.

10. The method of claim 9, where the deterministically chosen final value is a function of shot position.

11. A system comprising:
survey sources; and
a controller to:
for frequencies less than a predetermined frequency, simultaneously activate the survey sources to be in phase; and
for frequencies greater than the predetermined frequency, control phases of signals emitted by the simultaneously-activated survey sources to be different, wherein the controlling includes applying a smoothing function in a specified frequency range including the predetermined frequency to smooth a transition of the phases of the signals from a lower frequency to a higher frequency.

12. The system of claim 11, wherein the lower frequency range is the predetermined frequency, and the higher frequency includes a frequency greater than the predetermined frequency.

13. The system of claim 11, wherein the survey sources include seismic vibrators.

14. The system of claim 11, wherein the survey sources are simultaneously activated if the survey sources are activated within a specified time of one another such that energy produced by a first of the survey sources contributes to measured data for another of the survey sources.

15. The system of claim 11, wherein a distance between the survey sources is selected based on a shortest wavelength of a target signal to be measured.

16. The system of claim 11, wherein the predetermined frequency is a cutoff frequency based on a shortest wavelength of a target signal to be measured.

17. The system of claim 11, wherein the predetermined frequency is a cutoff frequency selected based on whether surface waves are to be preserved in measured data.

18. The system of claim 11, wherein the smoothing function is a function of a variable that is based on a difference between an original sweep instantaneous frequency and the predetermined frequency, wherein the original sweep instantaneous frequency is an instantaneous frequency of a sweep prior to application of a phase encoding function that provides the phases of the signals emitted by the survey sources, the phase encoding function including the smoothing function that produces a value that changes monotonically from an initial value for a first frequency to a final value for a second frequency.

19. The system of claim 11, wherein the controller is to randomize phases of the signals at frequencies greater than the specified frequency range.

20. An article comprising at least one non-transitory machine-readable storage medium storing instructions that upon execution cause a system to:
control signals produced by survey sources according to a frequency of the signals, the controlling comprising:
controlling the survey sources to be in phase for frequencies less than a first frequency; and
for frequencies greater than the first frequency, control phases of signals emitted by the survey sources to be different, wherein the controlling includes applying a smoothing function in a specified frequency range starting at the first frequency and ending at a second frequency to smooth a transition of the phases of the signals from the first frequency to the second frequency.
